(19) United States
(12) Patent Application Publication
(10) Pub. No.: US 2018/0239505 A1
(43) Pub. Date: Aug. 23, 2018

(54) CUSTOMIZATION OF CONTENT

(71) Applicant: International Business Machines Corporation, Armonk, NY (US)

(72) Inventor: Reena M. Jana, New York, NY (US)

(21) Appl. No.: 15/440,193

(22) Filed: Feb. 23, 2017

(51) Int. Cl. G06F 3/0484; G06F 17/21; G06F 17/22; G06F 3/0482

(52) U.S. Cl. CPC G06F 3/0484; G06F 17/218; H04L 67/22; G06F 3/0482; G06F 17/2247

(57) ABSTRACT

Embodiments are directed to a computer-implemented method, computer system, and computer program product for customizing the presentation of a work. The method includes receiving, by a processor, a work. Thereafter, receiving, by the processor, a tagging of the work. Then receiving, by the processor, a request to view the work by a user. Thereafter, determining, by the processor, a set of characteristics of the user. Finally, causing, by the processor, the presentation of one or more portions of the work to the user, the portions being presented to the user being selected based at least in part on the set of characteristics and the tagging of the work.

### BACKGROUND

The present invention relates in general to the field of computing. More specifically, the present invention relates to systems, methodologies and computer program products for controlling content that is viewed by a user.

As more people use websites and other forms of online content, it becomes more desirable to have content that is customized for each user. Typically, this is accomplished by providing so-called targeted content. In such a situation, certain links or advertisements can be customized for each user. For example, a news website can display news articles that could be of interest to a user based on previous news articles that the user viewed. Similarly, a video sharing site can display links to videos that are, at least in part, based on previous videos watched by the user. An advertisement server can display advertisements based on a user's previous browsing history.

### SUMMARY

Embodiments of the invention are directed to a computer-implemented method of customizing the presentation of a work. The method includes receiving, by a processor, a work. The method also includes receiving, by the processor, a tagging of the work. The method also includes receiving, by the processor, a request to view the work by a user. The method also includes determining, by the processor, a set of characteristics of the user. The method also includes causing, by the processor, the presentation of one or more portions of the work to the user. The portions that are presented to the user being selected based at least in part on the set of characteristics and the tagging of the work.

Embodiments of the invention are directed to a computer system for customizing the presentation of a work. The computer system includes a memory and a processor system communicatively coupled to the memory. The processor system is configured to perform the following: receiving, by a processor, a work. The method also includes receiving, by the processor, a tagging of the work. The method also includes receiving, by the processor, a request to view the work by a user. The method also includes determining, by the processor, a set of characteristics of the user. The method also includes causing, by the processor, the presentation of one or more portions of the work to the user. The portions that are presented to the user being selected based at least in part on the set of characteristics and the tagging of the work.

Embodiments are further directed to a computer program product for customizing the presentation of a work. The computer program product includes a computer-readable storage medium having program instructions embodied therewith. The program instructions are readable by a processor system to cause the processor system to perform a method that includes the following: receiving, by a processor, a work. The method also includes receiving, by the processor, a tagging of the work. The method also includes receiving, by the processor, a request to view the work by a user. The method also includes determining, by the processor, a set of characteristics of the user. The method also includes causing, by the processor, the presentation of one or more portions of the work to the user. The portions that are presented to the user being selected based at least in part on the set of characteristics and the tagging of the work.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter that is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a flow diagram illustrating the operation of one or more embodiments of the invention;

FIG. 2 depicts a flow diagram illustrating the operation of one or more embodiments of the invention;

FIG. 3 depicts a computer system capable of implementing hardware components of one or more embodiments of the invention;

FIG. 4 depicts a diagram of a computer program product according to one or more embodiments of the invention; and

FIG. 5 depicts a screen shot of one or more embodiments of the invention.

### DETAILED DESCRIPTION

Various embodiments of the present invention will now be described with reference to the related drawings. Alternate embodiments can be devised without departing from the scope of this invention. Various connections might be set forth between elements in the following description and in the drawings. These connections, unless specified otherwise, can be direct or indirect, and the present description is not intended to be limiting in this respect. Accordingly, a coupling of entities can refer to either a direct or an indirect connection.

Additionally, although a detailed description of a computing device is presented, configuration and implementation of the teachings recited herein are not limited to a particular type or configuration of computing device(s). Rather, embodiments are capable of being implemented in conjunction with any other type or configuration of wireless or non-wireless computing devices and/or computing environments, now known or later developed.

Furthermore, although a detailed description of usage with specific devices is included herein, implementation of the teachings recited herein are not limited to embodiments described herein. Rather, embodiments are capable of being implemented in conjunction with any other type of electronic device, now known or later developed.

There are many on-line places where a user can access content. It would be desirable to have the actual content of individual works customized based on characteristics of the user. As described above, there are systems in which a list of content that is available to a user can be customized to a certain extent. In exemplary situations, a combination of cookies, location sensing, and other techniques can be used to control a list of works that are presented available to a user. A news website can determine a user's location using one of a variety of different methods (for example, using global positioning satellite or WiFi network information on a mobile device or using an internet service provider's (ISP) information to locate the user). Thereafter, sports scores for local teams, weather, and local news can be displayed to a user. Similarly, such a news website can use cookies or other tracking information to determine previous news articles that the user has previously viewed. Thereafter, links to news articles that are related to the previously viewed news articles can be presented to the user.

Another example is advertising servers. An advertising server uses cookies to determine other websites that a user has visited. Thereafter, advertisements are displayed to the user that are intended to be of particular interest to the user.

As discussed above, there is a limited amount of content customization available to users. For the most part, such content customization is limited to controlling the choices made available to a user. For example, a user who is detected to be located in New York city can be shown links to local news articles that are different than the links to a user located in Miami, Fla. A user who has previously watched music videos by one particular artist can be shown links to other videos by that artist. A user who has previously purchased parts for a particular car can be shown advertisements for owners of that car.

While such customization serves a purpose, there are limitations. In particular, such customization only customizes which links or articles or videos are made available to a user, not the actual content of works displayed to a user. While references can be made to a work being an “article,” it should be understood that the definition is not so limited. A work can include any piece of writing (including both fiction and non-fiction, short-form and long-form, and the like), as well as any audio/visual content (such as photographs, audio recordings, and video recordings).

Embodiments of the present invention address customization issues by using a novel method and system to allow a user to customize the content of each individual work, based on a variety of characteristics such as the user's role or location. More particularly, content of an individual work can be tagged for a variety of different factors, such as role and location. When the content is displayed to the user, it can be customized based on the tags. In addition, a filtering component allows the offering of related information to the user.

Methods and systems of various embodiments modify the content of individual works. In one exemplary embodiments, a first user who is interested in computer technology might view a particular work. A second user who is interested in legal issues might view attempt to view the same work. However, the actual work being presented to the first user is different than the work being presented to the second user. In this particular example, the first user might be presented with details that are of particular interest to one in the computer technology field. The second user's display of the work might not contain those computer technology field, but can instead contain a detailed discussion of legal issues that was not presented to the first user.

At least the features and combinations of features described in the immediately present application, including the corresponding features and combinations of features depicted in the figures amount to significantly more than customizing content. Additionally, at least the features and combinations of features described in the immediately following paragraphs, including the corresponding features and combinations of features depicted in the figures go beyond what is well understood, routine and conventional in the relevant field(s).

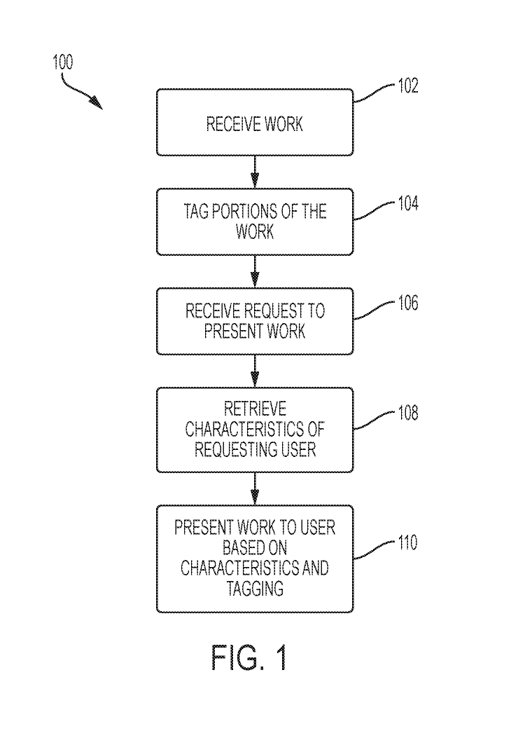

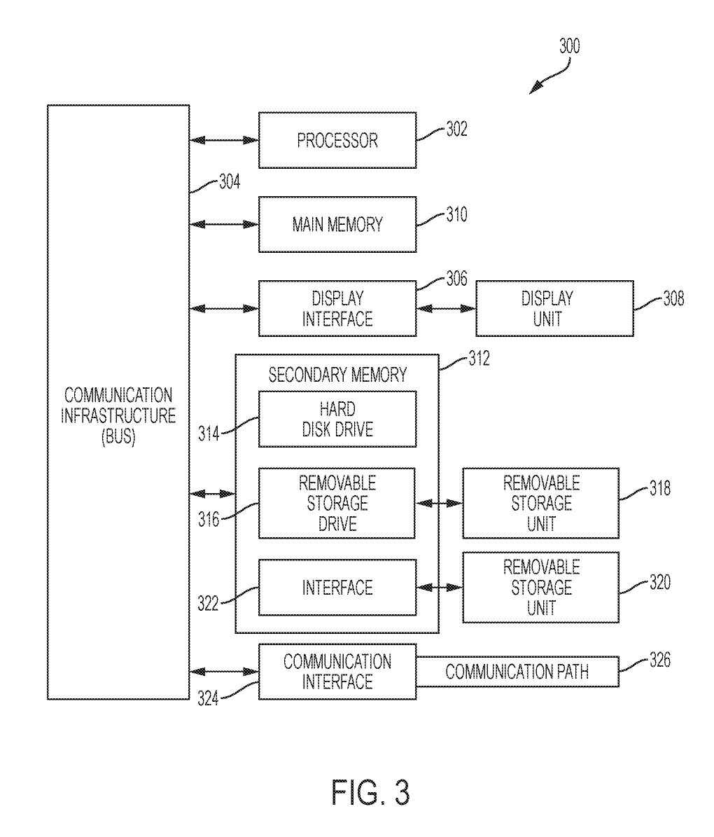

A flowchart illustrating method 100 is presented in FIG. 1. Method 100 is merely exemplary and is not limited to the embodiments presented herein. Method 100 can be employed in many different embodiments or examples not specifically depicted or described herein. In some embodiments, the procedures, processes, and/or activities of method 100 can be performed in the order presented. In other embodiments, one or more of the procedures, processes, and/or activities of method 100 can be combined or skipped. In some embodiments, portions of method 100 can be implemented by system 300 (FIG. 3).

Method 100 presents a flow for the creation and presentation of an individual work. A work is received (such as via an upload to a system) (block 102). Thereafter, portions of the work are tagged (block 104). The tagging can occur in one of a variety of different manners and may be in one of a variety of different forms. In some embodiments, a markup language can be used to provide tags.

A markup language is a system for annotating a document. The tags contain a variety of information about the document. Exemplary markup languages include hypertext markup language (HTML), extensible markup language (XML), and standard generalized markup language (SGML). In a markup language, tags can be placed around certain text to indicate aspects of the text. For example, html uses the tag <b> at the beginning of text block and the tag </b> to indicate to a browser that the tagged text is to be displayed in a bold font.

A variant of an XML can be used to indicate tag portions of each work. For example, a tag can be placed to indicate the role that a particular portion of the work is intended for. Roles can be as broad or narrow as desired by a content creator. Exemplary roles can include executive, student (which can include basic information), technical (which can include advanced information about technical topics), legal (which can include legal issues), and the like. In another exemplary usage, there can be roles that a subsets of other roles. For example, the student role can include an elementary sub-role, a middle school sub-role, a high school sub-role, and a college sub-role, with each sub-role providing more sophisticated information than the next sub-role. In such a use case, a work or an article about the Internet can include four consecutive paragraphs, with each paragraph containing a set of tags that indicate the role. Other roles can be present, such as age and gender.

In another aspect of some embodiments, a user-controlled filtering function can be provided on a website. Instead of having article choices being determined in the background, there can be a dropdown box or other user interface element that allows a user both to choose the list of article choices being presented to the user and to customize the content of individual works. This will be described in further detail below.

In some embodiments, the tagging of a work is performed manually, such as by an administrator. In some embodiments, tagging of a work is performed by a machine-learning algorithm. A combination of approaches can also be used. While the above description discusses a text-based work, it should be understood that embodiments are not so limited. Other types of works can also be tagged in a similar manner. For example, audio works can have portions of the audio work tagged in a similar manner. Visual works, such as photographs, illustrations, drawings, paintings, motion pictures, and the like, can also be tagged. The term audiovisual work can be used to refer to audio works, visual works, and combinations thereof. In some embodiments, metadata associated with a video, audio, or audiovisual work can be tagged. Thus, the metadata can note, for example, that a portion of a work lasting from time stamp 31 seconds to time stamp 39 seconds has one tag and that other portions have other tags.

Thereafter, a request is received to present a particular work (block 106). The request can occur in one of a variety of different manners. In a web-based embodiment, the request can be received as a click on a link in a browser window. When the request is received, characteristics of the requesting user are retrieved (block 108).

The characteristics of the requesting user can include a variety of different information. For example, the location of the user can be determined in one of a variety of different manners, such as a GPS location of the user's mobile device, via the ISP being used by the user, or by information previously submitted by the user to indicate the user's location. In a similar manner, the role of the user can be determined by information previously submitted by the user at the particular website. In some embodiments, the role of the user can be determined based on a user's history at the website, such as articles previously viewed, or demographics of the user as determined in one of a variety of different manners.

Thereafter, the work is caused to be displayed or presented to the user based on the role and location information (110). This can be accomplished in one of a variety of different manners. In some examples, tags of the article are read. Thereafter, only tags that are appropriate to the role of the user are displayed to the user. Portions of the work that are within tags that are not appropriate to the user can be skipped so they are not displayed.

For example, if the “role” of the user is “attorney”, then a paragraph of an article that is tagged with <role=attorney> will be displayed to that user. But a paragraph that is tagged with <role=marketing>. It should be understood that the tags presented above are merely exemplary. Any type of tagging scheme can be used in an embodiment.

In a similar manner, locality tags can be used in some articles. For example, an article about a winter storm could have different paragraphs regarding the local effects of the storm. A paragraph of an article with a tag such as <locality=NY> might only be shown to users located in New York, while a paragraph with a tag such as <locality=MD> might only be shown to users located in Maryland. It should be understood that locality can be as broad or narrow as users define it. In some articles, locality can be important down to the neighborhood of a city. In some articles, locality can encompass regions that are as large as a country or even a continent.

There can be other options also. For example, a user can request to be shown paragraphs for multiple roles. In some embodiments, a user can request to see all paragraphs, without regards to any tagging.

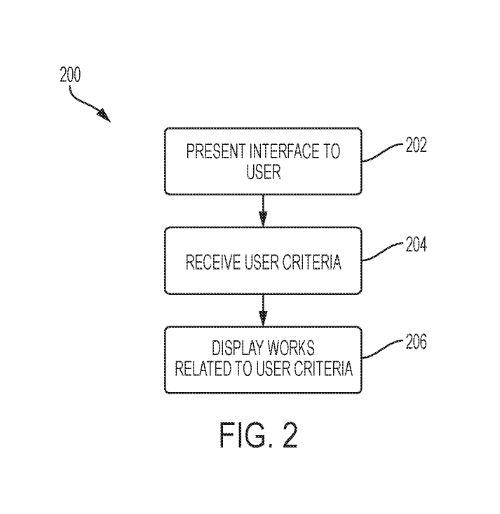

A flowchart illustrating method 200 is presented in FIG. 2. Method 200 is merely exemplary and is not limited to the embodiments presented herein. Method 200 can be employed in many different embodiments or examples not specifically depicted or described herein. In some embodiments, the procedures, processes, and/or activities of method 200 can be performed in the order presented. In other embodiments, one or more of the procedures, processes, and/or activities of method 200 can be combined or skipped. In some embodiments, portions of method 200 can be implemented by system 300 (FIG. 3).

Method 200 illustrates the above-described filtering feature. The tagging described above can also be used include bibliographic information about each article (author, title, brief summary, date, and the like). Thereafter, there can be a mechanism where a user can can set a filter such that similar articles, such as articles by the same author, or covering a similar topic, or other limitations can be set.

Method 200 will be presented under the assumption that works have already been tagged. If they have not been tagged yet, blocks 102 through 104 of method 100 can be performed.

An interface is presented to the user (block 202). The interface allows a user to set one or more filter criteria. In some embodiments, one or more drop-down boxes can be used. In some embodiments, the drop-down boxes can be supplemented with areas for text entry. Other user interface elements can be used, including, but not limited to, radio buttons, check boxes, and the like. Collectively, these may be referred to as user interface elements. For example, in the drop-down box, the user can select the aspect being filtered (such as author, subject, date, and the like). In the text entry area, can select the criteria being searched for.

After receiving the user's selection criteria (block 204), a content database can be searched to find works that match the user's selection criteria. Thereafter, the works (or links to the works) can be displayed to the user (block 206). In some embodiments, the webpage can have a sidebar that is separate from the area where works are displayed. In such an embodiment, the sidebar can contain the links to the works.

For an exemplary use case, there can be a situation where a user is visiting a website and views a work that is of interest to the user. The user can then use the drop-down boxes or other user interface element to set the criteria that the user finds interesting about the work being viewed. In some embodiments, criteria matching the currently viewed work can be placed as a pre-set. In such a manner, the user can quickly browse through a list of other works that could be of interest to the user (such as works concerning the same subject, works by the same author, and the like).

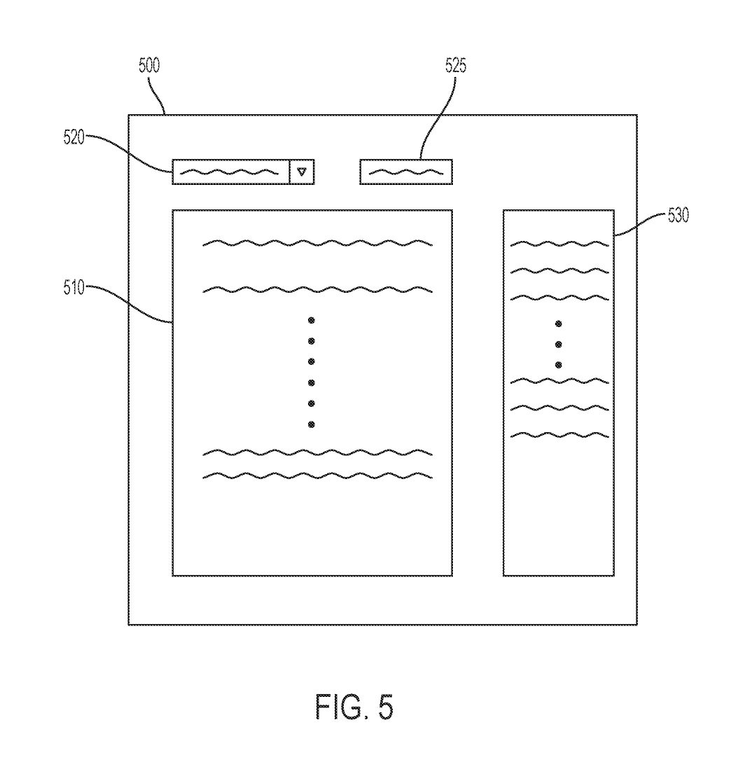

With reference to FIG. 5, an exemplary screen shot is shown that illustrates the operation of an exemplary embodiment. Window 500 displays that content being viewed by the user. Window 500 can be located within a browser window, for example. The content of a work being viewed by the user is displayed in section 510. As shown in FIG. 5, the work is a piece of text. However, any type of work can be present in some embodiments. The text that is being shown can be tagged text, as discussed above with respect to FIG. 1, in that only sections of the text with the appropriate tags are being displayed to the user.

User interface elements 520 and 525 are present above section 510. As illustrated in FIG. 5, user interface element 520 is a drop-down box and user interface element 525 is a text box. However, any type of user interface element can be present. Based on the selections made by the user via user interface elements 520 and 525, links are shown in link area 530. Link area 530 can be dynamic. In other words, every time the user changes an entry in user interface elements 520 and 525, the links shown in link area 530 can be changed.

It should be understood that the layout shown in FIG. 5 is merely exemplary. The placement of each of the elements can be changed with no change in functionality. There can be fewer or additional user interface elements present in some embodiments.

FIG. 3 depicts a high-level block diagram of a computer system 300, which can be used to implement one or more embodiments. More specifically, computer system 300 can be used to implement hardware components of systems capable of performing methods described herein. Although one exemplary computer system 300 is shown, computer system 300 includes a communication path 326, which connects computer system 300 to additional systems (not depicted) and can include one or more wide area networks (WANs) and/or local area networks (LANs) such as the Internet, intranet(s), and/or wireless communication network(s). Computer system 300 and additional system are in communication via communication path 326, e.g., to communicate data between them. Computer system 300 can have one of a variety of different form factors, such as a desktop computer, a laptop computer, a tablet, an e-reader, a smartphone, a personal digital assistant (PDA), and the like.

Computer system 300 includes one or more processors, such as processor 302. Processor 302 is connected to a communication infrastructure 304 (e.g., a communications bus, cross-over bar, or network). Computer system 300 can include a display interface 306 that forwards graphics, textual content, and other data from communication infrastructure 304 (or from a frame buffer not shown) for display on a display unit 308. Computer system 300 also includes a main memory 310, preferably random access memory (RAM), and can include a secondary memory 312. Secondary memory 312 can include, for example, a hard disk drive 314 and/or a removable storage drive 316, representing, for example, a floppy disk drive, a magnetic tape drive, or an optical disc drive. Hard disk drive 314 can be in the form of a solid state drive (SSD), a traditional magnetic disk drive, or a hybrid of the two. There also can be more than one hard disk drive 314 contained within secondary memory 312. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disc, etc. which is read by and written to by removable storage drive 316. As will be appreciated, removable storage unit 318 includes a computer-readable medium having stored therein computer software and/or data.

In alternative embodiments, secondary memory 312 can include other similar means for allowing computer programs or other instructions to be loaded into the computer system. Such means can include, for example, a removable storage unit 320 and an interface 322. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 320 and interfaces 322 which allow software and data to be transferred from the removable storage unit 320 to computer system 300.

Computer system 300 can also include a communications interface 324. Communications interface 324 allows software and data to be transferred between the computer system and external devices. Examples of communications interface 324 can include a modem, a network interface (such as an Ethernet card), a communications port, or a PC card slot and card, a universal serial bus port (USB), and the like. Software and data transferred via communications interface 324 are in the form of signals that can be, for example, electronic, electromagnetic, optical, or other signals capable of being received by communications interface 324. These signals are provided to communications interface 324 via communication path (i.e., channel) 326. Communication path 326 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 310 and secondary memory 312, removable storage drive 316, and a hard disk installed in hard disk drive 314. Computer programs (also called computer control logic) are stored in main memory 310 and/or secondary memory 312. Computer programs also can be received via communications interface 324. Such computer programs, when run, enable the computer system to perform the features discussed herein. In particular, the computer programs, when run, enable processor 302 to perform the features of the computer system. Accordingly, such computer programs represent controllers of the computer system. Thus it can be seen from the forgoing detailed description that one or more embodiments provide technical benefits and advantages.

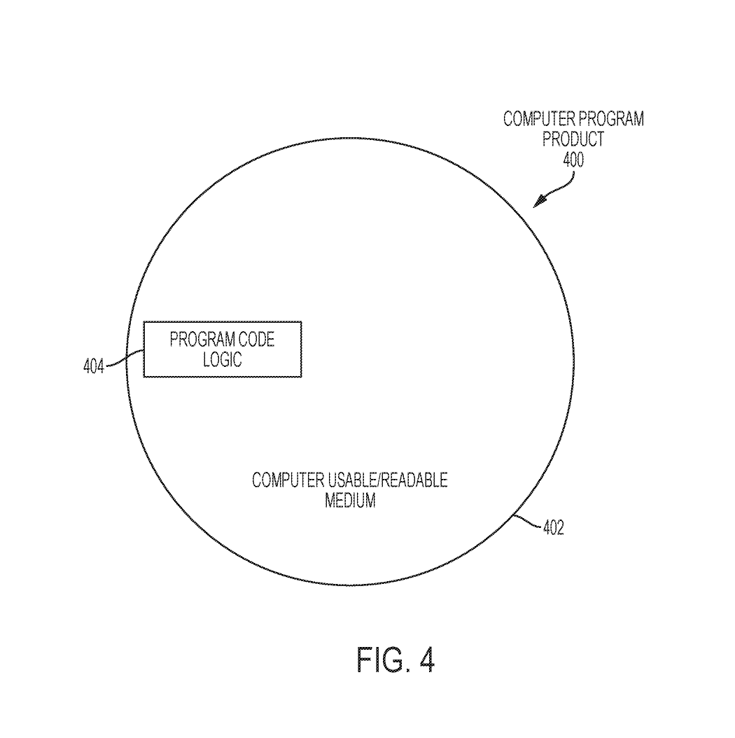

Referring now to FIG. 4, a computer program product 400 in accordance with an embodiment that includes a computer-readable storage medium 402 and program instructions 404 is generally shown.

Embodiments can be a system, a method, and/or a computer program product. The computer program product can include a computer-readable storage medium (or media) having computer-readable program instructions thereon for causing a processor to carry out aspects of embodiments of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out embodiments can include assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions can execute entirely on the consumer's computer, partly on the consumer's computer, as a stand-alone software package, partly on the consumer's computer and partly on a remote computer or entirely on the remote computer or server. In the latter scenario, the remote computer can be connected to the consumer's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform embodiments of the present invention.

Aspects of various embodiments are described herein with reference to flowchart illustrations and/or block diagrams of methods, apparatus (systems), and computer program products according to various embodiments. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The descriptions presented herein are for purposes of illustration and description, but is not intended to be exhaustive or limited. Many modifications and variations will be apparent to those of ordinary skill in the art without departing from the scope and spirit of embodiments of the invention. The embodiment was chosen and described in order to best explain the principles of operation and the practical application, and to enable others of ordinary skill in the art to understand embodiments of the present invention for various embodiments with various modifications as are suited to the particular use contemplated.

What is claimed is:

1. A computer-implemented method for customizing the presentation of a work, the method comprising:
receiving, by a processor, a work;
receiving, by the processor, a tagging of the work;
receiving, by the processor, a request to view the work by a user;
determining, by the processor, a set of characteristics of the user; and
causing, by the processor, the presentation of one or more portions of the work to the user, the portions being presented to the user being selected based at least in part on the set of characteristics and the tagging of the work.

2. The computer-implemented method of claim 1, wherein:
the set of characteristics of the user include a location of the user, a role of the user, a location of the user, interests of the user, demographic information of the user, and a history of the user.

3. The computer-implemented method of claim 2, wherein:
the history of the user comprises historical data regarding the user's previous Internet browsing history.

4. The computer-implemented method of claim 1, wherein:
tagging the work comprises placing an XML tag around a portion of the work to indicate that the portion of the work is to be displayed based on characteristics listed in the XML tag.

5. The computer-implemented method of claim 1, wherein:
tagging the work comprises creating a metadata file that indicates characteristics of portions of an associated audiovisual work.

6. The computer-implemented method of claim 1, further comprising:
causing the presentation of one or more user interface elements to a user; and
causing the presentation of one or more links to the user based on selections made in the user interface elements; wherein
the user interface elements are configured to allow a user to select tags upon which filtering is to be applied.

7. The computer-implemented method of claim 6, wherein:
a default value of a tag is selected from a currently viewed work.

8. A computer system for customizing the presentation of a work, the system comprising:
a memory; and
a processor system communicatively coupled to the memory;
the processor system configured to:
receive a work;
receive a tagging of the work;
receive a request to view the work by a user;
determine a set of characteristics of the user; and
cause the presentation of one or more portions of the work to the user, the portions being presented to the user being selected based at least in part on the set of characteristics and the tagging of the work.

9. The computer system of claim 8, wherein:
the set of characteristics of the user include a location of the user, a role of the user, a location of the user, interests of the user, demographic information of the user, and a history of the user.

10. The computer system of claim 9, wherein:
the history of the user comprises historical data regarding the user's previous Internet browsing history.

11. The computer system of claim 8, wherein:
tagging the work comprises placing an XML tag around a portion of the work to indicate that the portion of the work is to be displayed based on characteristics listed in the XML tag.

12. The computer system of claim 8, wherein:
tagging the work comprises creating a metadata file that indicates characteristics of portions of an associated audiovisual work.

13. The computer system of claim 8, wherein the processor is further configured to:
cause the presentation of one or more user interface elements to a user; and
cause the presentation of one or more links to the user based on selections made in the user interface elements; wherein
the user interface elements are configured to allow a user to select tags upon which filtering is to be applied.

14. The computer system of claim 13, wherein:
a default value of a tag is selected from a currently viewed work.

15. A computer program product for customizing the presentation of a work, comprising:
a computer-readable storage medium having program instructions embodied therewith, wherein the computer-readable storage medium is not a transitory signal per se, the program instructions readable by a processor system to cause the processor system to perform a method comprising:
receiving a work;
receiving a tagging of the work;
receiving a request to view the work by a user;
determining a set of characteristics of the user; and
causing the presentation of one or more portions of the work to the user, the portions being presented to the user being selected based at least in part on the set of characteristics and the tagging of the work.

16. The computer program product of claim 15, wherein:
the set of characteristics of the user include a location of the user, a role of the user, a location of the user, interests of the user, demographic information of the user, and a history of the user.

17. The computer program product of claim 16, wherein:
the history of the user comprises historical data regarding the user's previous Internet browsing history.

18. The computer program product of claim 15, wherein:
tagging the work comprises placing an XML tag around a portion of the work to indicate that the portion of the work is to be displayed based on characteristics listed in the XML tag.

19. The computer program product of claim 8, wherein:
tagging the work comprises creating a metadata file that indicates characteristics of portions of an associated audiovisual work.

20. The computer program product of claim 8, wherein the instructions are further configured to:
cause the presentation of one or more user interface elements to a user; and
cause the presentation of one or more links to the user based on selections made in the user interface elements; wherein
the user interface elements are configured to allow a user to select tags upon which filtering is to be applied.
